(19) United States
(12) Patent Application Publication
(10) Pub. No.: US 2012/0002990 A1
(43) Pub. Date: Jan. 5, 2012

(54) IMAGE FORMING APPARATUS AND IMAGE FORMING METHOD

(75) Inventor: Toshifumi TAKEUCHI, Shizuoka (JP)

(73) Assignees: Toshiba Tec Kabushiki Kaisha, Tokyo (JP); Kabushiki Kaisha Toshiba, Tokyo (JP)

(21) Appl. No.: 13/167,666

(22) Filed: Jun. 23, 2011

Related U.S. Application Data
(60) Provisional application No. 61/361,364, filed on Jul. 2, 2010.

(51) Int. Cl. G03G 15/00; G03G 15/06; G03G 15/02; G03G 15/20; G03G 15/043

(52) U.S. Cl. 399/49; 399/70; 399/51; 399/50; 399/55

(57) ABSTRACT

Certain embodiments provide an image forming apparatus comprising an image forming part, a detection part, an arithmetic part, a storage device and an image quality maintaining control part. The image forming part forms an image quality maintaining adjustment pattern on a transfer belt to convey a sheet. The detection part detects the image quality adjustment pattern. The arithmetic part calculates, based on a detection result of the image quality maintaining adjustment pattern obtained by the detection part, image quality maintaining information for forming an image of desired image quality. The storage device stores the image quality maintaining information before the image forming apparatus transitions to a sleep mode. The image quality maintaining control part reads the image quality maintaining information from the storage device and controls the image forming part based on the read image quality maintaining information before the image forming apparatus returns after the sleep mode is released.

### CROSS-REFERENCE TO RELATED APPLICATION

This application is based upon and claims the benefit of priority from Provisional U.S. Applications 61/361,364 filed on Jul. 2, 2010, the entire contents of which are incorporated herein by reference.

### FIELD

Embodiments described herein relates generally to an image forming apparatus and an image forming method.

### BACKGROUND

In an image forming apparatus in which a color image is obtained by superimposing plural toner images, positions of plural toner images and densities of the plural toner images are changed by an environment in the image forming apparatus. In a related art image forming apparatus, in order to maintain the image quality of a color image, position adjustment among plural toner images and density adjustment among plural toner images are performed after the image forming apparatus returns from a sleep state (a state in which in order to suppress power consumption, a heating operation of a fixing device to fix a toner image to a sheet is stopped, and power is not supplied to a part of a scanner part to read a document).

However, when a time taken to perform the image quality maintaining adjustment to maintain the image quality of a color image becomes long, the user's waiting time taken to return (to become a printable state) after the sleep mode of the image forming apparatus is released becomes long. For example, in the related art image forming apparatus, the user's waiting time is about 40 seconds, and in the time, the time taken for the image quality maintaining adjustment is about 30 seconds. Accordingly, it is desired that the time for the image quality maintaining adjustment is shortened and the user's waiting time is shortened.

### DESCRIPTION OF THE DRAWINGS

FIG. 1 is a schematic structural view showing an image forming apparatus of an embodiment.

FIG. 2 is a perspective view showing an image quality maintaining sensor.

FIG. 3 is a block diagram showing a control system of the image forming apparatus and mainly relating to image adjustment.

FIG. 4 is a flowchart showing an image forming method of the embodiment.

FIG. 5 is a flowchart showing a method of calculating a position adjustment value of the embodiment.

FIG. 6 is a schematic explanatory view showing patterns printed on a transfer belt of the embodiment.

FIG. 7 is an explanatory view for setting an adjustment value of image inclination from the patterns of the embodiment.

FIG. 8 is an explanatory view showing an inclination shift on a photoconductive drum of the embodiment.

FIG. 9 is an explanatory view showing a toner image resulting from the inclination shift of the embodiment.

FIG. 10 is an explanatory view for setting an adjustment value of a writing start timing shift in a sub-scanning direction from patterns of the embodiment.

FIG. 11 is an explanatory view showing the writing start timing shift in the sub-scanning direction on the photoconductive drum of the embodiment.

FIG. 12 is an explanatory view showing a toner image resulting from the writing start timing shift in the sub-scanning direction of the embodiment.

FIG. 13 is an explanatory view for setting an adjustment value of a writing start timing shift in a main scanning direction from patterns of the embodiment.

FIG. 14 is an explanatory view showing the writing start timing shift in the main scanning direction on the photoconductive drum of the embodiment.

FIG. 15 is an explanatory view showing a toner image resulting from the writing start timing shift in the main scanning direction of the embodiment.

FIG. 16 is an explanatory view for setting an adjustment value of a main scanning magnification shift from patterns of the embodiment.

FIG. 17 is an explanatory view showing the main scanning magnification shift on the photoconductive drum of the embodiment.

FIG. 18 is an explanatory view showing a toner image resulting from the main scanning magnification shift of the embodiment.

FIG. 19 is a flowchart showing a method of calculating a density adjustment value of the embodiment.

FIG. 20 is an explanatory view showing a patch of the embodiment.

FIG. 21 is an explanatory view showing a relation between an image density and a detection value of a density sensor of the embodiment.

### DETAILED DESCRIPTION

In general, according to one embodiment, an image forming apparatus includes an image forming part, a detection part, an arithmetic part, a storage device and an image quality maintaining control part. The image forming part forms an image quality maintaining adjustment pattern on a transfer belt to convey a sheet. The detection part detects the image quality maintaining adjustment pattern. The arithmetic part calculates, based on a detection result of the image quality maintaining adjustment pattern obtained by the detection part, image quality maintaining information for forming an image of desired image quality. The storage device stores the image quality maintaining information before the image forming apparatus transitions to a sleep mode. The image quality maintaining control part reads the image quality maintaining information from the storage device and controls the image forming part based on the read image quality maintaining information before the image forming apparatus returns after the sleep mode of the image forming apparatus is released.

According to another embodiment, an image forming method includes forming an image quality maintaining adjustment pattern, detecting the image quality maintaining adjustment pattern, calculating image quality maintaining information, storing the image quality maintaining information in a storage device, and controlling an image forming part. The image quality maintaining adjustment pattern is formed by the image forming part on a transfer belt to convey a sheet. The image quality maintaining information is information for forming an image of desired image quality and is calculated based on a detection result of the image quality maintaining adjustment pattern. The calculated image quality maintaining information is stored in the storage device before an image forming apparatus transitions to a sleep mode. The image quality maintaining information is read from the storage device and the image forming part is controlled based on the read image quality maintaining information before the image forming apparatus returns after the sleep mode of the image forming apparatus is released.

Hereinafter, an image forming apparatus and an image forming method of an embodiment will be described.

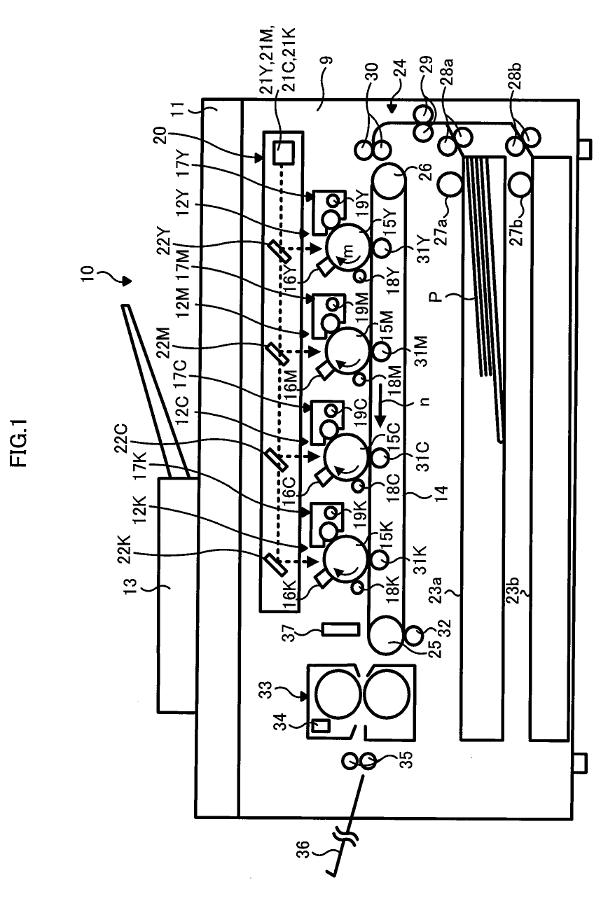

FIG. 1 is a schematic structural view showing the image forming apparatus of the embodiment. The image forming apparatus is a four-tandem color copier.

The color copier 10 shown in FIG. 1 includes a scanner part 11 and an image forming part 9. The scanner part 11 reads a document supplied by an auto document feeder 13 and forms image data based on the read document.

The image forming part 9 includes plural image forming stations 12Y, 12M, 12C and 12K and a laser exposure device 20.

The plural image forming stations 12Y, 12M, 12C and 12K are four sets of image forming stations of yellow (Y), magenta (M), cyan (C) and black (K), and are arranged in parallel along an after-mentioned transfer belt 14. The plural image forming stations 12Y, 12M, 12C and 12K form image quality maintaining adjustment patterns (a position adjustment pattern and a density adjustment pattern) on the transfer belt 14 as described later, and form a copy image in which toner images of plural colors are superimposed on a sheet P.

The respective image forming stations 12Y, 12M, 12C and 12K include photoconductive drums 15Y, 15M, 15C and 15K as image carriers. The photoconductive drums 15Y, 15M, 15C and 15K are arranged so that their rotation axes are directed in a direction (main scanning direction) perpendicular to a running direction (sub-scanning direction) of an arrow n direction of the after-mentioned transfer belt 14. The rotation axes of the respective photoconductive drums 15Y, 15M, 15C and 15K are provided at equal intervals.

The respective image forming stations 12Y, 12M, 12C and 12K include charging chargers 16Y, 16M, 16C and 16K, developing devices 17Y, 17M, 17C and 17K, and photoreceptor cleaners 18Y, 18M, 18C and 18K around the respective photoconductive drums 15Y, 15M, 15C and 15K. The charging chargers 16Y, 16M, 16C and 16K, the developing devices 17Y, 17M, 17C and 17K, and the photoreceptor cleaners 18Y, 18M, 18C and 18K are arranged in this order along the rotation direction (arrow m direction in the drawing) of the respective photoconductive drums 15Y, 15M, 15C and 15K.

The developing devices 17Y, 17M, 17C and 17K of the respective colors include therein toner charging amount control units 19Y, 19M, 19C and 19K for charging toner.

The laser exposure device 20 includes laser oscillators 21Y, 21M, 21C and 21K of the respective colors, and plural tilt mirrors 22Y, 22M, 22C and 22K, and is arranged over the respective image forming stations 12Y, 12M, 12C and 12K.

The laser exposure device 20 emits laser beams of desired intensities based on image data formed by the scanner part 11 from the respective laser oscillators 21Y, 21M, 21C and 21K at desired timings. The laser exposure device 20 uses the tilt mirrors 22Y, 22M, 22C and 22K and guides the emitted laser beams to desired positions based on the image data on the surfaces of the respective photoconductive drums 15Y, 15M, 15C and 15K.

The surfaces of the photoconductive drums 15Y, 15M, 15C and 15K are uniformly charged by the charging charger 16Y, 16M, 16C and 16K. When the laser exposure device 20 irradiates the laser beams to the uniformly charged surfaces of the photoconductive drums 15Y, 15M, 15C and 15K, charged electrostatic latent images are formed on the surfaces of the photoconductive drums 15Y, 15M, 15C and 15K so that toners charged by the toner charging amount control units 19Y, 19M, 19C and 19K in the developing devices 17Y, 17M, 17C and 17K are adsorbed. The developing devices 17Y, 17M, 17C and 17K supply the charged toners to the surfaces of the respective photoconductive drums 15Y, 15M, 15C and 15K and form toner images of the respective color components coincident with the electrostatic latent images.

The color copier 10 includes a first and a second paper feed cassette 23a and 23b including the sheet P, and a conveyance part 24 to convey the sheet P. The conveyance part 24 includes the transfer belt 14, a drive roller 25, a driven roller 26, pickup rollers 27a and 27b, separation conveyance rollers 28a and 28b, a conveyance roller 29 and a register roller 30. The pickup rollers 27a and 27b take out the sheet P from the first and the second paper feed cassette 23a and 23b provided in the color copier 10. The separation conveyance rollers 28a and 28b, the conveyance roller 29 and the register roller 30 convey the sheet P taken out from the first and the paper feed cassette 23a and 23b onto the transfer belt 14. The transfer belt 14, the drive roller 25 and the driven roller 26 rotate in the arrow n direction, and convey the sheet P on the transfer belt 14 in the arrow n direction.

The color copier 10 includes four transfer rollers 31Y, 31M, 31C and 31K as transfer parts. The four transfer rollers 31Y, 31M, 31C and 31K correspond to the respective photoconductive drums 15Y, 15M, 15C and 15K, and are provided at positions facing the photoconductive drums 15Y, 15M, 15C and 15K across the transfer belt 14. The respective transfer rollers 31Y, 31M, 31C and 31K transfer the toner images on the photoconductive drums 15Y, 15M, 15C and 15K onto the sheet P conveyed in the arrow n direction or the transfer belt 14 rotating in the arrow n direction. Incidentally, after the respective toner images are transferred, the photoreceptor cleaners 18Y, 18M, 18C and 18K clean the toner remaining on the photoconductive drums 15Y, 15M, 15C and 15K. Further, when toner images (a toner image as a position adjustment pattern and a toner image as a density adjustment pattern) as the after-mentioned image quality maintaining adjustment patterns are transferred onto the transfer belt 14, the belt cleaner 32 of the color copier 10 removes the toner images on the transfer belt 14.

The color copier 10 includes a fixing device 33. The fixing device 33 fixes the copy image formed on the sheet P to the sheet P. The fixing device 33 includes therein a temperature sensor 34 to detect the temperature of the fixing device 33.

The color copier 10 includes a paper discharge roller 35 and a paper discharge tray 36. The paper discharge roller 35 discharges the sheet P on which the copy image is fixed to the paper discharge tray 36.

The color copier 10 includes an image quality maintaining sensor 37 as a detection part to detect the image quality maintaining adjustment pattern. The image quality maintaining sensor 37 is disposed above the transfer belt 14 between the image forming station 12K of black (K) and the fixing device 33, and the longitudinal direction of the image quality maintaining sensor 37 is directed in the main scanning direction.

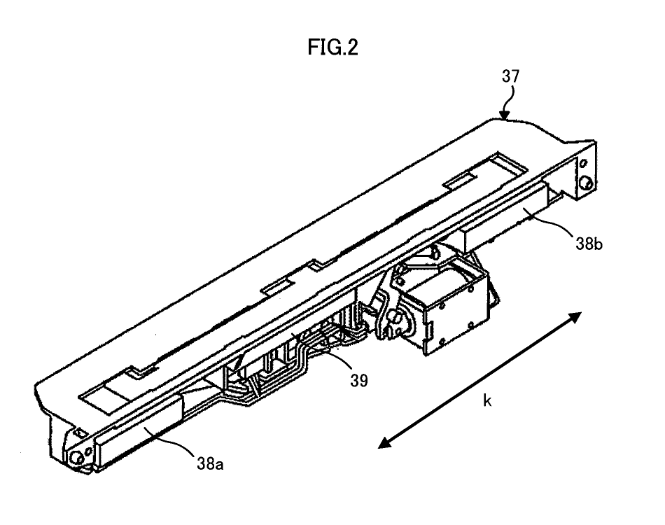

FIG. 2 is a perspective view showing the image quality maintaining sensor 37. As shown in FIG. 2, the image quality maintaining sensor 37 includes two positioning sensors 38a and 38b to detect the position shift of each toner image, and a toner adhesion amount sensor 39 as a density detection part to detect the density of each toner image. The longitudinal direction of the image quality maintaining sensor 37 is an arrow k direction in the drawing. The two positioning sensors 38a 38b, and the toner adhesion amount sensor 39 are provided along the longitudinal direction in the order of the positioning sensor 38a, the toner adhesion amount sensor 39 and the positioning sensor 38b in sequence from the near side in the drawing. The two positioning sensors 38a and 38b are respectively provided at portions corresponding to both sides of the transfer belt 14, and the toner adhesion amount sensor 39 is provided at an intermediate position between the two positioning sensors 38a and 38b. The image quality maintaining sensor 37 is disposed so that the positioning sensors 38a and 38b and the toner adhesion amount sensor 39 face the transfer belt 14.

The two positioning sensors 38a and 38b detect the position adjustment patterns formed on the transfer belt 14. The detection result is used for shift correction of toner images of the respective colors transferred onto the sheet P.

The toner adhesion amount sensor 39 detects the density adjustment patterns of the respective colors formed on the transfer belt 14. The detection result is used for density correction of toner images of the respective colors transferred onto the sheet P.

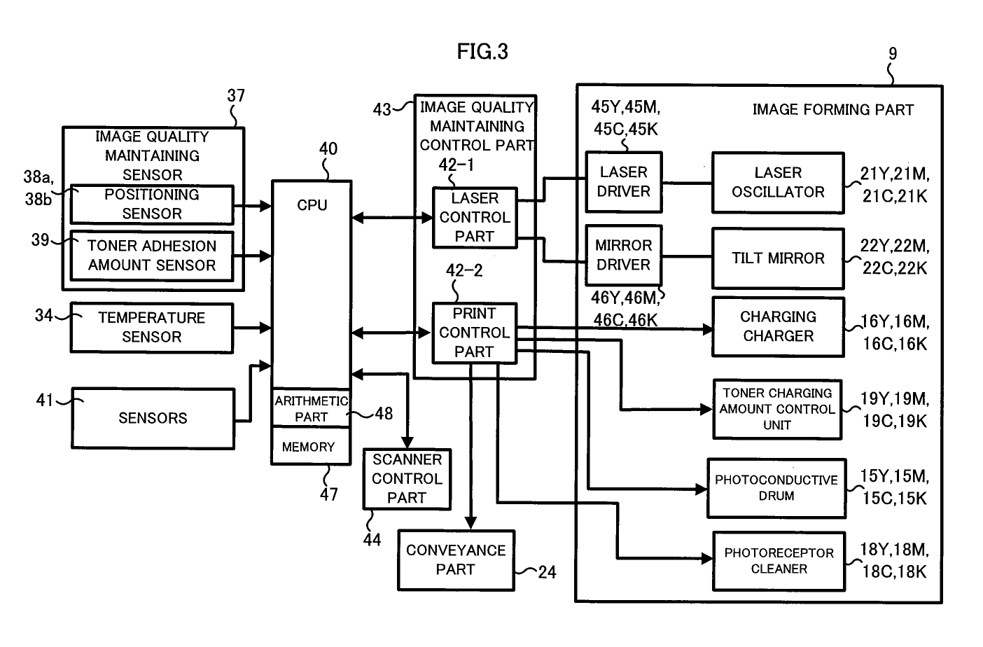

FIG. 3 is a block diagram showing a control system of the color copier 10 and mainly relating to image adjustment. The color copier 10 performs, for example, positioning adjustment of toner images of the respective colors and density adjustment of toner images of the respective colors as image quality maintaining control. However, as the image quality maintaining control, only one of them may be performed.

The control system includes a CPU 40 to control the whole color copier 10. The two positioning sensors 38a and 38b as the image quality maintaining sensor 37, the toner adhesion amount sensor 39, the temperature sensor 34, and other sensors 41 necessary for image formation are respectively connected to the CPU 40. Besides, an image quality maintaining control part 43 including a laser control part 42-1 and a print control part 42-2, and a scanner control part 44 are respectively connected to the CPU 40.

The laser control part 42-1 controls laser drivers 45Y, 45M, 45C and 45K. The controlled laser drivers 45Y, 45M, 45C and 45K drive the laser oscillators 21Y, 21M, 21C and 21K of the respective colors so that laser beams are emitted with desired intensities and at desired emitting timings.

The laser control part 42-1 controls mirror drivers 46Y, 46M, 46C and 46K. The controlled mirror drivers 46Y, 46M, 46C and 46K rotate the tilt mirrors 22Y, 22M, 22C and 22K so that laser beams are irradiated to desired positions.

The print control part 42-2 controls the toner charging amount control units 19Y, 19M, 19C and 19K. The controlled toner charging amount control units 19Y, 19M, 19C and 19K charge toners in the developing devices 17Y, 17M, 17C and 17K of the respective colors to desired charge amounts.

The print control part 42-2 controls the charging chargers 16Y, 16M, 16C and 16K. The controlled charging chargers 16Y, 16M, 16C and 16K charge the surfaces of the photoconductive drums 15Y, 15M, 15C and 15K of the respective colors to desired potentials.

Further, the print control part 42-2 controls the photoconductive drums 15Y, 15M, 15C and 15K, the photoreceptor cleaners 18Y, 18M, 18C and 18K and the conveyance part 24.

The scanner control part 44 controls the scanner part 11 including the auto document feeder 13.

The CPU 40 includes a nonvolatile memory 47 such as, for example, an HDD (Hard Disk Drive). The memory 47 stores image quality maintaining information. When the image quality maintaining information is supplied to the image quality maintaining control part 43, the image quality maintaining control part 43 sets the image forming part 9 so as to form a copy image of desired image quality.

The image quality maintaining information includes density adjustment values for adjusting densities of toner images of the respective colors to desired densities, and position adjustment values for adjusting positions of toner images of the respective colors to desired positions.

The density adjustment values include development bias values for adjusting toner charge amounts in the developing devices 17Y, 17M, 17C and 17K of the respective colors, charging bias values for adjusting surface potentials of the photoconductive drums 15Y, 15M, 15C and 15K of the respective colors, and laser power adjustment values for adjusting intensities of laser beams irradiated to the surfaces of the photoconductive drums 15Y, 15M, 15C and 15K of the respective colors.

When the CPU 40 supplies development bias values to the print control part 42-2, the print control part 42-2 controls the toner charging amount control units 19Y, 19M, 19C and 19K based on the development bias values, and charges the toner.

When the CPU 40 supplies charging bias values to the print control part 42-2, the print control part 42-2 controls the charging chargers 16Y, 16M, 16C and 16K based on the charging bias values, and uniformly charges the surfaces of the photoconductive drums 15Y, 15M, 15C and 15K of the respective colors.

When the CPU 40 supplies the laser power adjustment values to the laser control part 42-1, the laser control part 42-1 sets the laser power adjustment values in the laser drivers 45Y, 45M, 45C and 45K. The laser drivers 45Y, 45M, 45C and 45K cause the laser oscillators 21Y, 21M, 21C and 21K of the respective colors to emit laser beams based on the set laser power adjustment values.

The position adjustment values include mirror position adjustment values for guiding the respective laser beams emitted from the laser oscillators 21Y, 21M, 21C and 21K to desired positions on the surfaces of the photoconductive drums 15Y, 15M, 15C and 15K of the respective colors, and timing adjustment values for emitting the respective laser beams emitted from the laser oscillators 21Y, 21M, 21C and 21K at desired timings. Incidentally, the timing adjustment values include main scanning direction timing adjustment values indicating emitting timings of the respective laser beams in the main scanning direction, sub-scanning direction timing adjustment values indicating emitting timings of the respective laser beams in the sub-scanning direction, and a clock frequency adjustment value indicating the emitting interval of the laser beam.

When the CPU 40 supplies the mirror position adjustment values to the laser control part 42-1, the laser control part 42-1 sets the mirror position adjustment values in the mirror drivers 46Y, 46M, 46C and 46K. The mirror drivers 46Y, 46M, 46C and 46K rotate the tilt mirrors 22Y, 22M, 22C and 22K based on the set mirror position adjustment values.

When the CPU 40 supplies the timing adjustment values to the laser control part 42-1, the laser control part 42-1 sets the timing adjustment values in the laser drivers 45Y, 45M, 45C and 45K. The laser drivers 45Y, 45M, 45C and 45K cause the laser oscillators 21Y, 21M, 21C and 21K of the respective colors to emit the laser beams based on the set timing adjustment values.

Besides, the memory 47 stores timer information. The timer information is information for causing the color copier 10 to automatically transition to a sleep state (state in which in order to suppress power consumption, a heating operation of the fixing device 33 is stopped, and power is not supplied to a part of the scanner part 11 to read a document). The timer information is such information that when a state where the color copier 10 is not operated continues for ten minutes, the color copier 10 transitions to the sleep mode, or the color copier 10 transitions to the sleep mode at 1 a.m. every day.

Further, the memory 47 stores control programs for the whole color copier 10, including acquisition of the image quality maintaining information, supply of the image quality maintaining information, execution of the sleep function for causing the color copier 10 to transition to the sleep mode, and execution of printing after the return from the sleep mode. The control program is configured to acquire the image quality maintaining information immediately before the sleep function is executed (for example, 5 minutes before), and to supply the image quality maintaining information to the image quality maintaining control part 43 during the period from the release of the sleep mode to the return. Further, the control program is configured to form a copy image when the fixing device 33 reaches a specified temperature after the color copier 10 returns from the sleep mode.

Further, the memory 47 stores position adjustment pattern information for forming the position adjustment patterns, density adjustment pattern information for forming the density adjustment patterns, density target range of the density adjustment pattern, and reference temperature of the fixing device 33 for starting formation of the copy image on the sheet P.

Incidentally, the memory 47 stores, for example, the image data formed by the scanner part 11 in addition to the above.

The CPU 40 includes an arithmetic part 48. The arithmetic part 48 calculates the image quality maintaining information, that is, the position adjustment values and the density adjustment values based on the detection result of the image quality maintaining sensor 37.

The image quality maintaining information is acquired by arithmetic operation using the detection result of the image quality maintaining adjustment patterns formed on the transfer belt 14. The acquired image quality maintaining information is once stored in the memory 47, and is supplied to the image quality maintaining control part 43 during the period from the release of the sleep mode of the color copier 10 to the return.

The position adjustment values are acquired by arithmetic operation using the detection result of the position adjustment patterns formed on the transfer belt 14. The obtained position adjustment values are once stored in the memory 47, and are supplied to the laser control part 42-1 during the period from the release of the sleep mode of the color copier 10 to the return.

The density adjustment values are acquired by arithmetic operation using the detection result of the patches of the respective colors formed on the transfer belt 14. The obtained density adjustment values are once stored in the memory 47, and are supplied to the laser control part 42-1 and the print control part 42-2 during the period from the release of the sleep mode to the return.

The CPU 40 controls the scanner control part 44, the laser control part 42 and the print control part 43, so that the copy image is formed on the sheet P, and the image quality maintaining adjustment patterns are formed on the transfer belt 14.

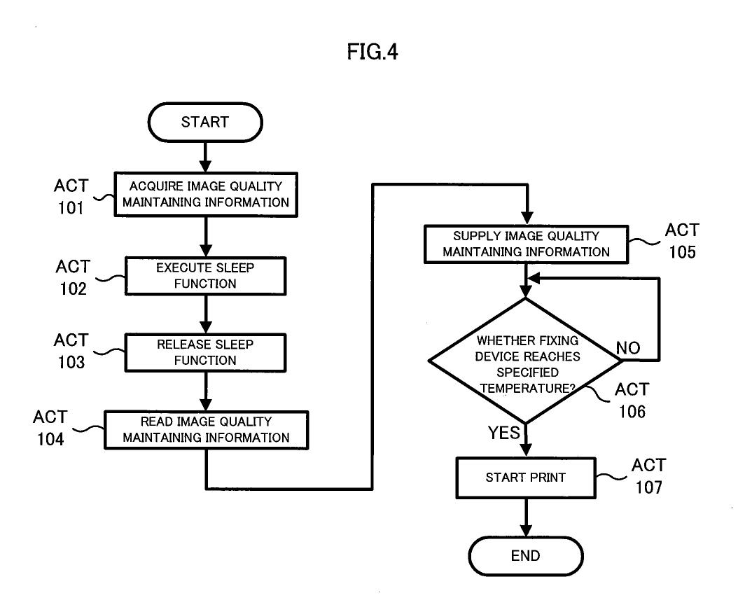

Next, the image forming method of the color copier 10 will be described with reference to FIG. 4. In the following description, it is assumed that the timer information is stored in the memory 47 so that when the state where the color copier 10 is not operated continues for 10 minutes, the color copier 10 transitions to the sleep mode, and the control program is configured to calculate and to acquire the image quality maintaining information 5 minutes before the transition to the sleep mode (that is, when the state where the color copier 10 is not operated continues for 5 minutes).

FIG. 4 is a flowchart showing the image forming method of the embodiment. When the state where the color copier 10 is not operated continues for 5 minutes, as shown in FIG. 4, the arithmetic part 48 calculates and acquires the image quality maintaining information (Act 101). When acquiring the image quality maintaining information, the CPU 40 stores the information in the memory 47. Incidentally, a specific calculation method of the image quality maintaining information, that is, the density adjustment values and the position adjustment values will be described later.

Next, when the state where the color copier 10 is not operated continues for 10 minutes, the CPU 40 causes the color copier 10 to transition to the sleep mode based on the timer information (Act 102). By this, the color copier 10 transitions to the sleep mode in the state where the image quality maintaining information is stored in the memory 47.

Thereafter, when the user places a document on the auto document feeder 13 and operates the color copier 10 in order to read the document by the scanner part 11, the sleep mode is released, and the color copier 10 starts an operation to return from the sleep mode (Act 103). Incidentally, when the document is read by the scanner part 11 by the user's operation, the scanner part 11 forms image data. The formed image data is stored in the memory 47.

When the sleep mode of the color copier 10 is released at the above Act, the CPU 40 reads the image quality maintaining information from the memory 47 before the color copier 10 returns from the sleep mode (Act 104). Incidentally, the CPU 40 preferably reads the image quality maintaining information from the memory 47 simultaneously with the release of the sleep mode of the color copier 10.

Next, the CPU 40 supplies the read image quality maintaining information to the image quality maintaining control part 43 (Act 105). When the image quality maintaining information is supplied to the image quality maintaining control part 43, the image quality maintaining control part 43 controls the image forming part 9 so that the copy image of desired image quality can be formed based on the image quality maintaining information.

Next, the CPU 40 detects the temperature of the fixing device 33 by the temperature sensor 34, and compares the detected temperature with the reference temperature previously stored in the memory 47 (Act 106). As a result, when the detected temperature is equal to or higher than the reference temperature (YES at Act 106), the CPU 40 controls the print control part 43 and the conveyance part 24, and forms the copy image on the sheet P based on the image data stored in the memory 47 (Act 107).

At the above comparison Act, when the detected temperature is lower than the reference temperature (NO at ACT 106), the CPU 40 suspends the formation of the copy image on the sheet P for a specified time. After the suspension for the specified time, the above Act (Act 106) is again performed. At this time, when the detected temperature is equal to or higher than the reference temperature, the copy image is formed on the sheet P based on the image data stored in the memory 47 (Act 107). When the detected temperature is lower than the reference temperature, the formation of the copy image on the sheet P is further suspended for the specified time.

Incidentally, the CPU 40 automatically executes the above Acts in accordance with the control program stored in the memory 47.

Next, as the specific calculation method of the image quality maintaining information, the specific calculation method of the position adjustment values and the density adjustment values will be described with reference to FIG. 5 to FIG. 25.

(1) Calculation of the Position Adjustment Values

The position adjustment values are calculated by image positioning adjustment. FIG. 5 is a flowchart showing a method of calculating the position adjustment values. Hereinafter, the calculation method of the position adjustment values will be described with reference to FIG. 5.

When the image positioning adjustment starts, the image forming stations 12Y, 12M, 12C and 12K form a set of position adjustment patterns of four colors of Y, M, C and K on the transfer belt 14 (Act 201).

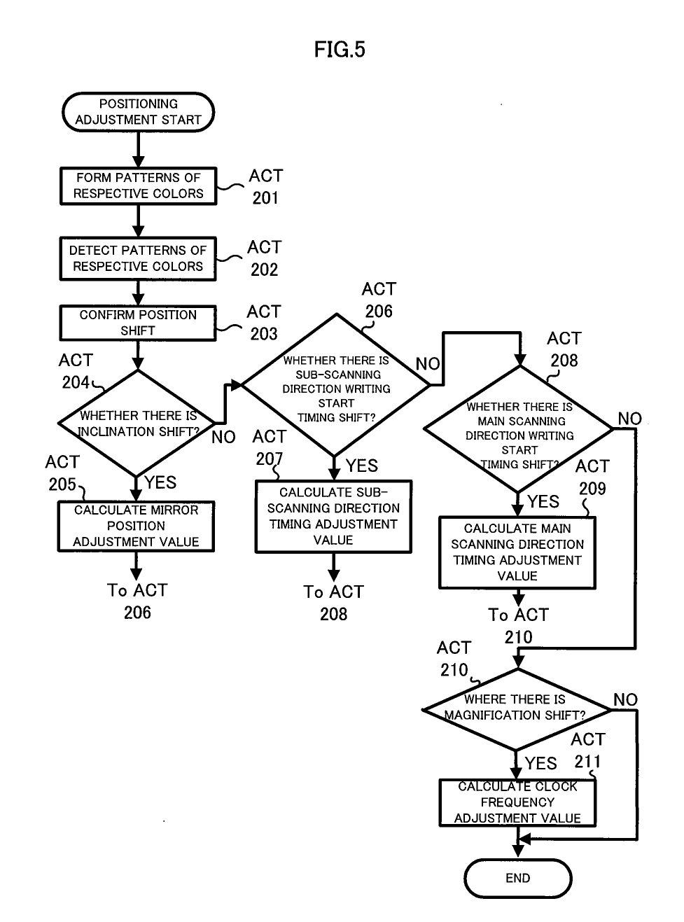

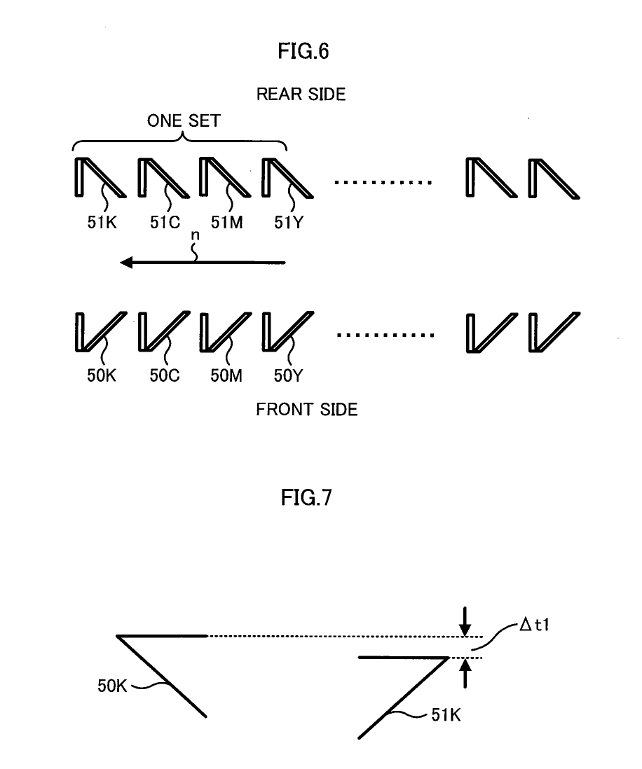

As shown in FIG. 6, the position adjustment patterns include wedge-type patterns 50 and 51, and a specified number of sets (hereinafter, 8 sets as an example) of position adjustment patterns are formed on the transfer belt 14. The image forming stations 12Y, 12M, 12C and 12K form 8 sets of patterns 50Y, 50M, 50C and 50K on the front side of the transfer belt 14, and form 8 sets of patterns 51Y, 51M, 51C and 51K on the rear side of the transfer belt 14.

Next, the positioning sensors 38a and 38b of the image quality maintaining sensor 37 detect and measure the 8 sets of position adjustment patterns 50Y, 50M, 50C, 50K, 51Y, 51M, 51C and 51K (Act 202).

Next, the arithmetic part 48 calculates the average value of the data obtained by the measurement, and the CPU 40 determines an image position shift (Act 203). The image position shift is caused by an image inclination, an image writing start timing and a magnification error.

(a) Adjustment of the Image Inclination

Case where as the result that the image position shift is determined at Act 203, as shown in FIG. 7, it is found that the output timing in the sub-scanning direction is shifted by Δt1 between the front side pattern 50K of black (k) and the rear side pattern 51K of black.

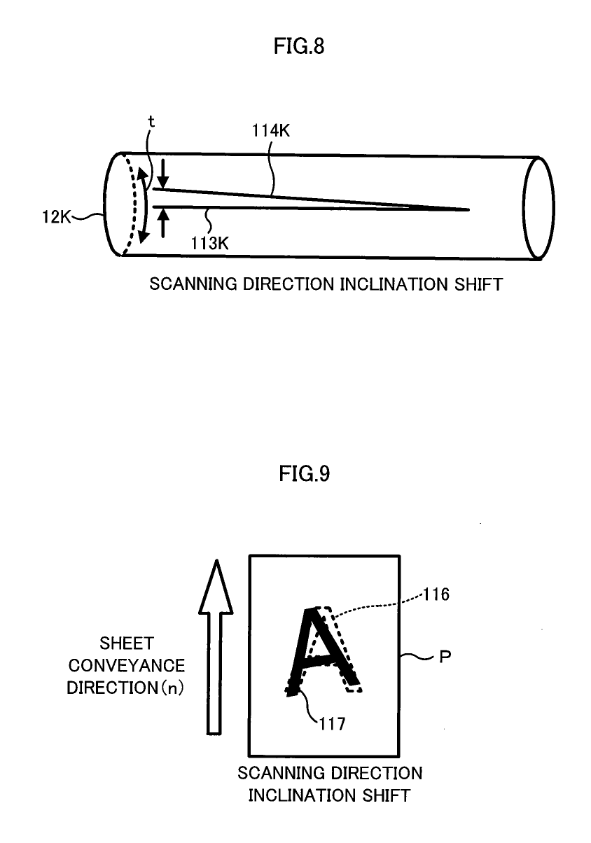

In this case, as shown in FIG. 8, the arithmetic part 48 determines that an axis 113K of the photoconductive drum 15K of black (K) and a scanning direction 114K of a laser beam by the laser oscillator 21K of black (K) are inclined with each other (Act 204).

When image formation is performed without adjustment, as shown in FIG. 9, a black toner image on the sheet P becomes a toner image 117 inclined as indicated by a solid line with respect to a proper position 116 indicated by a chain line.

At Act 204, when determining that the image is inclined, the arithmetic part 48 calculates the mirror position adjustment values of the tilt mirrors 22Y, 22M, 22C and 22K so that the inclination substantially becomes 0 (Act 205). The calculated mirror position adjustment values are stored in the memory 47.

(b) Adjustment of the Image Writing Start Timing

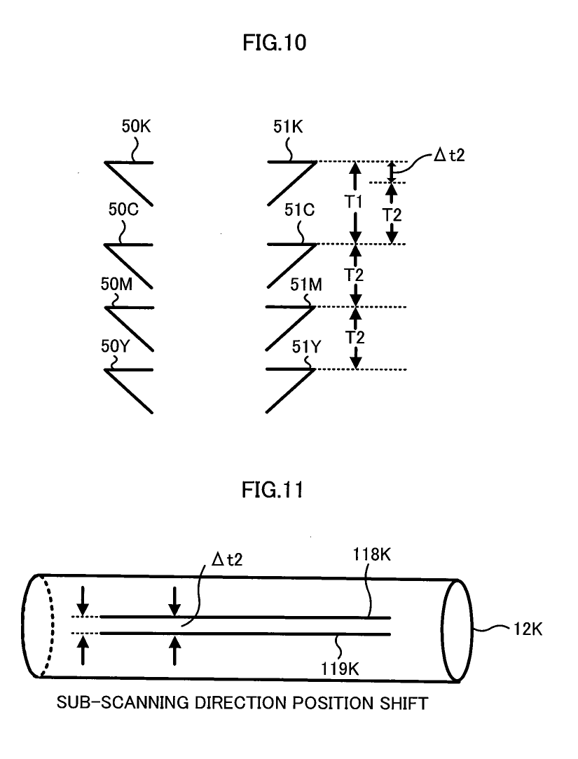

Case where as the result that the image position shift is determined at Act 203, for example, as shown in FIG. 10, it is found that an interval T1 between the pattern 50C, 51C of cyan and the pattern 50K, 51K of black is different from an interval T2 between other patterns.

In this case, as shown in FIG. 11, the arithmetic part 48 determines that a position 118K of the pattern 50K, 51K of black (K) is shifted from an original position 119K in the sub-scanning direction by Δt2 as a difference between the interval T1 and the interval T2 (Act 206).

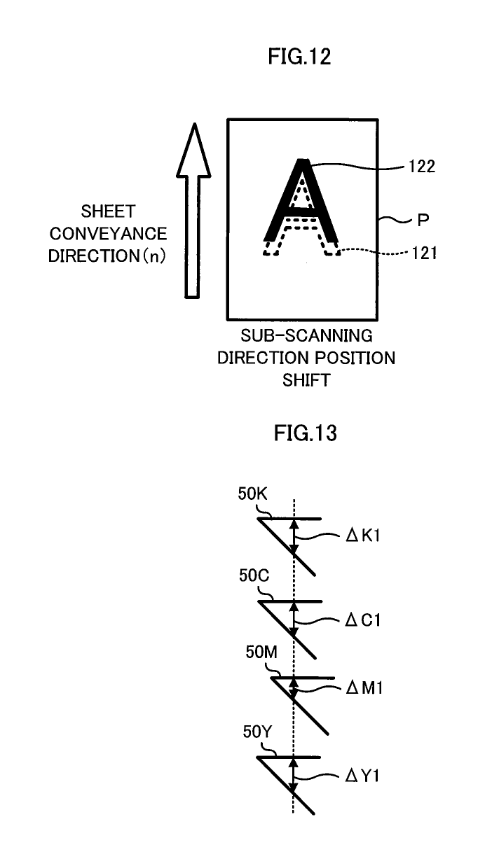

When image formation is performed without adjustment, as shown in FIG. 12, a toner image of black on the sheet P becomes a toner image 122 indicated by a solid line, the position of which is shifted in the sub-scanning direction with respect to a proper position 121 indicated by a chain line.

At Act 206, when determining that the position of the image is shifted in the sub-scanning direction, the arithmetic part 48 calculates the sub-scanning direction timing adjustment value of the laser oscillator 21K of black so that the position shift substantially becomes 0 (Act 207). The calculated sub-scanning direction timing adjustment value is stored in the memory 47.

Next, in the case where as the result that the image position shift is determined at Act 203, for example, as shown in FIG. 13, it is found that detection lengths ΔK1, ΔC1, ΔM1 and ΔY1 of the front side patterns 50Y, 50M, 50C and 50K are different from each other.

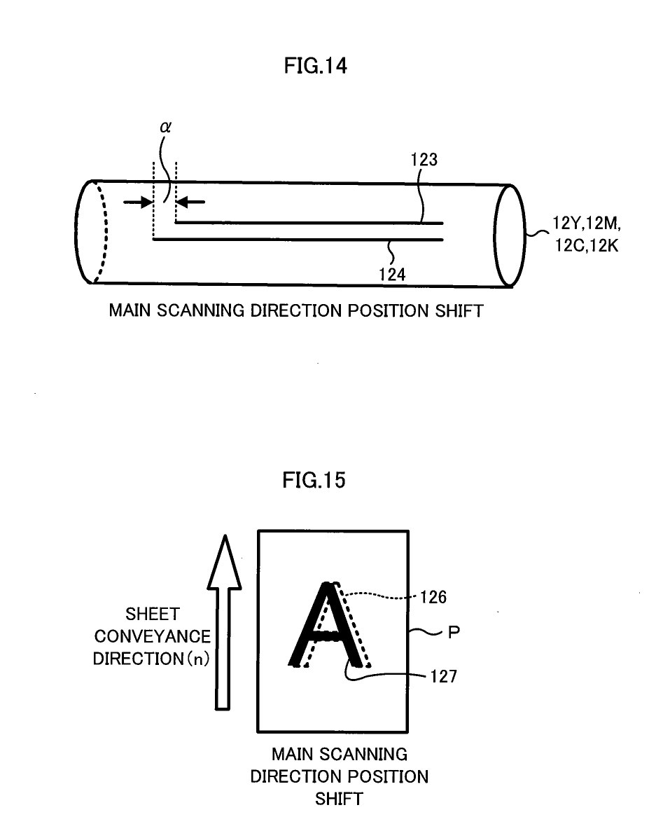

In this case, as shown in FIG. 14, the arithmetic part 48 determines that a position 123 of each color component is shifted in the main scanning direction by a with respect to an original position 124 (Act 208).

When image formation is performed without adjustment, as shown in FIG. 15, a toner image of each color formed on the sheet P becomes a toner image 127 indicated by a solid line, the position of which is shifted in the main scanning direction with respect to a proper position 126 indicated by a chain line. The amount of the image position shift in the main scanning direction is determined from the respective differences between the detection lengths ΔK1, ΔC1, ΔM1 and ΔY1 of the front side patterns 50Y, 50M, 50C and 50K.

At Act 208, when determining that the image position is shifted in the main scanning direction, the arithmetic part 48 calculates the main scanning direction timing adjustment values of the laser oscillators 21Y, 21M, 21C and 21K so that ΔK1=ΔC1=ΔM1=ΔY1 is established (Act 209). The calculated main scanning direction timing adjustment values are stored in the memory 47.

(c) Adjustment of the Magnification Error

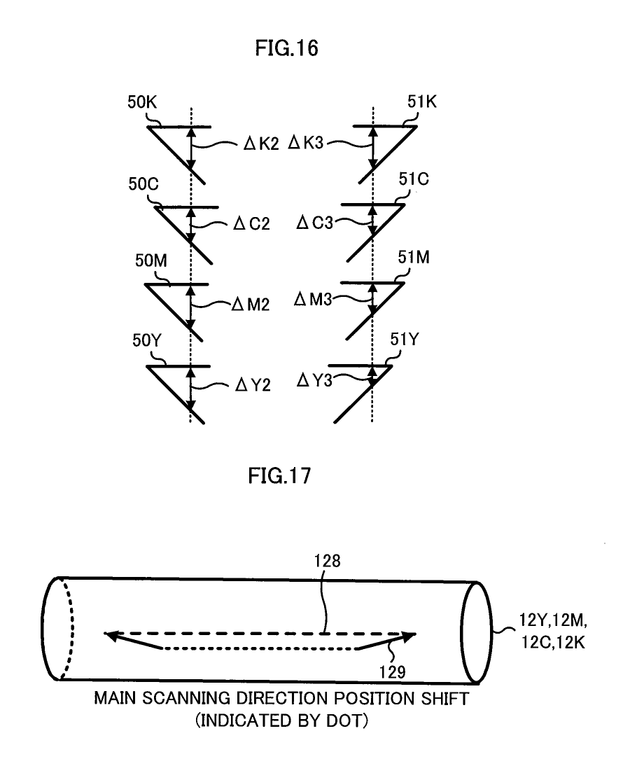

Case where as the result that the image position shift is determined at Act 203, for example, as shown in FIG. 16, it is found that detection lengths ΔK2, ΔC2, ΔM2 and ΔY2 of the front side patterns 50Y, 50M, 50C and 50K of the respective color components and detection lengths ΔK3, ΔC3, ΔM3 and ΔY3 of the rear side patterns 51Y, 51M, 51C and 51K are different from each other.

In this case, as shown in FIG. 17, the arithmetic part 48 determines that a dot interval of each color component 128 is different from a dot interval of an original pattern 129, and a magnification shift occurs in the main scanning direction (Act 210).

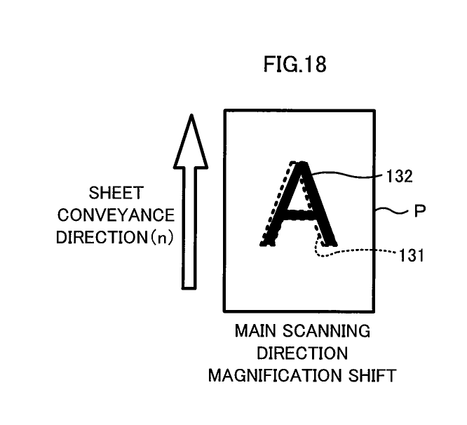

When image formation is performed without adjustment, as shown in FIG. 18, a toner image formed on the sheet P becomes a toner image 132 as indicated by a solid line, which is subjected to the magnification shift in the main scanning direction with respect to a proper image 131 indicated by a chain line. The amount of the image magnification shift in the main scanning direction is determined from values obtained by adding the respective front side detection lengths ΔK2, ΔC2, ΔM2 and ΔY2 of the respective color components and the respective rear side detection lengths ΔK3, ΔC3, ΔM3 and ΔY3. When (ΔK2+ΔK3)=(ΔC2+ΔC3)=(ΔM2+ΔM3)=(ΔY2+ΔY3) is established, it is determined that the image magnifications of the respective color components in the main scanning direction are constant.

At Act 210, when determining that the magnification shift occurs, the arithmetic part 48 calculates clock frequency adjustment values of the laser oscillators 21Y, 21M, 21C and 21K so that the magnification shift becomes substantially 0 (Act 211). The calculated clock frequency adjustment values are stored in the memory 47.

The position adjustment values are calculated by the method described above. In the foregoing method, as the example in which the shift with respect to the reference value of the pattern position included in the position adjustment pattern information stored in the memory 47 is adjusted, the description is made on the case where all the four colors are adjusted. As another method, one specified color (for example, black (K)) may be made the reference. The shift amounts of the other colors (for example, yellow (Y), magenta (M) and cyan (C)) with respect to the value of black (K) are adjusted and the shift may be resolved only by adjusting the three colors.

(II) Calculation of the Density Adjustment Value

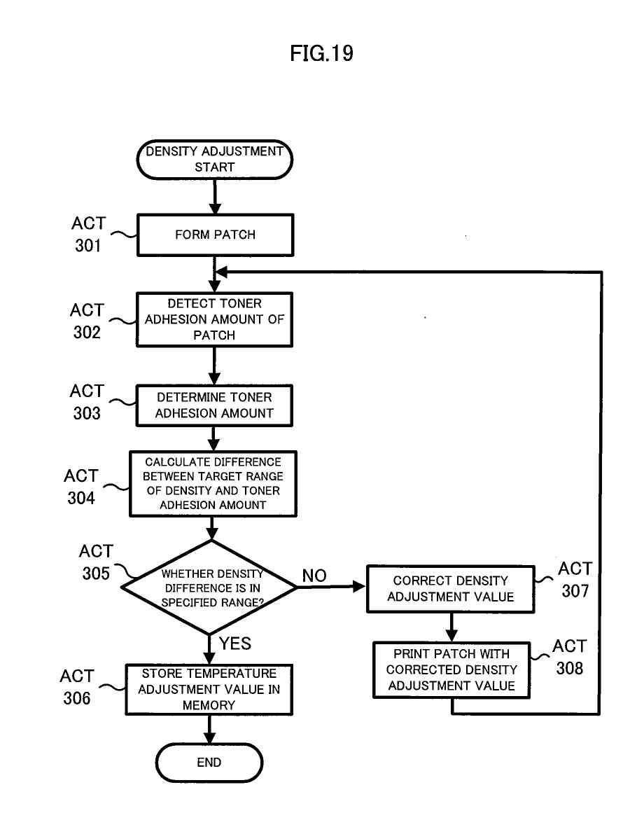

The density adjustment value is calculated by image density adjustment. FIG. 19 is a flowchart showing a method of calculating the density adjustment value. Hereinafter, the calculation method of the density adjustment value will be described with reference to FIG. 19. Incidentally, in the following description, although the calculation method of the density adjustment value for black (K) will be described, a calculation method of the density adjustment value for another color (yellow (Y), magenta (M), cyan (C)) is the same.

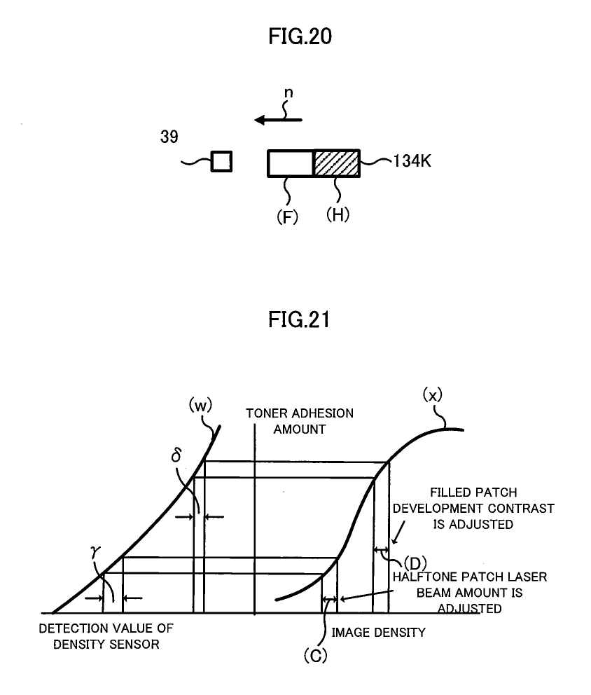

When the image density adjustment starts, the image forming station 12Y forms a density adjustment pattern of black (K) on the transfer belt 14 based on density adjustment pattern information stored in the memory 47 (ACT 301). As shown in FIG. 20, the density adjustment pattern of black (K) is a patch 134K of black (K) including a filled patch (F) and a halftone patch (H).

Next, the toner adhesion amount sensor 39 detects the toner adhesion amount of each of the filled patch (F) and the halftone patch (H) of the patch 134K (Act 302). The toner adhesion amount sensor 39 detects the toner adhesion amounts at, for example, 10 points of each of the filled patch (F) and the halftone patch (H).

Next, the arithmetic part 48 calculates the average of the detect ion values of the toner adhesion amount sensor 39 and determines the toner adhesion amount (Act 303).

Next, the arithmetic part 48 calculates a difference between a target range of density for black (K) stored in the memory 48 and the determined toner adhesion amount for black (K) (Act 304).

FIG. 21 shows a relation between the detection value of the toner adhesion amount sensor 39, the toner adhesion amount on the transfer belt 14, and the density. A solid line (w) indicates the detection value of the toner attachment amount sensor 39, and a solid line (x) indicates the toner adhesion amount on the transfer belt 14. With reference to FIG. 21, the range of the detection value of the toner adhesion amount sensor 39 is determined according to the target range of the image density. For example, when the target range of the density of the halftone patch H is (C), the range of the detection value of the toner adhesion amount sensor 39 is determined to be (γ). When the target range of the density of the filled patch F is (D), the range of the detection value of the toner adhesion amount sensor 39 is determined to be (δ).

The CPU 40 determines from the calculation result of Act 304 whether the difference of the density is in the specified range (Act 305). When the difference of the density is in the specified range (Yes at Act 305), the density adjustment value when the patch 134K is formed is stored in the memory 47 (Act 306).

As a result of the determination at Act 305, when the difference of the density exceeds the specified range (No at Act 305), the density adjustment value is corrected so that the difference of the density is in the specified range (Act 307).

Next, similarly to Act 301, the patch 134K is formed on the transfer belt 14 by using the corrected density adjustment value (Act 308).

Thereafter, at Act 305, until it is determined that the difference of the density is in the specified range, Act 307, 308, 302, 303, 304 and 305 are repeated in this order. As a result of the repetition, when it is determined at Act 305 that the difference of the density is in the specified range, the density adjustment value corrected at that time is stored in the memory 47 (Act 306).

Incidentally, when the density adjustment value is stored in the memory 47, the belt cleaner 32 removes the patterns 50 and 51 and the patch 134K on the transfer belt 14.

The calculation of the density adjustment value is executed for each color. However, when patches of the respective colors are simultaneously printed on the transfer belt 14 and are respectively read by the corresponding four toner adhesion amount sensors 39, the calculation time of the density adjustment values for the respective colors can be shortened.

According to the color copier 10 and the image forming method of the embodiment described above, the image quality maintaining information including the position adjustment values and the density adjustment values is calculated and is stored in the memory 47 before the color copier 10 transitions to the sleep mode. The image quality maintaining information stored in the memory 47 is read during the period from the release of the sleep mode of the color copier 10 to the return, and the laser drivers 45Y, 45M, 45C and 45K, the mirror drivers 46Y, 46M, 46C and 46K, the charging chargers 16Y, 16M, 16C and 16K, and the toner charging amount control units 19Y, 19M, 19C and 19K are controlled so that the copy image of desired image quality is obtained. Accordingly, the user's waiting time from the release of the sleep mode of the color copier to the start of printing can be shortened.

Incidentally, when the image quality maintaining information stored in the memory 47 is read simultaneously with the release of the sleep mode of the color copier 10, the user's waiting time can be further shortened.

For example, as the image density adjustment, the duty ratio of image data may be changed. In this case, before the color copier 10 transitions to the sleep mode, the duty ratio of the image data is calculated so that a copy image of desired density can be obtained and the duty ratio may be stored as the density adjustment value in the memory 47. The color copier 10 reads the duty ratio as the adjustment value from the memory 47 during the period from the release of the sleep mode to the return, and supplies the read duty ratio to the print control part 42-2. Then, the print control part 42-2 controls a PWM circuit which is provided in a part of the image forming part 9 and sets the duty ratio of pixel data.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An image forming apparatus comprising:
an image forming part to form an image quality maintaining adjustment pattern on a transfer belt to convey a sheet;
a detection part to detect the image quality maintaining adjustment pattern;
an arithmetic part to calculate, based on a detection result of the image quality maintaining adjustment pattern obtained by the detection part, image quality maintaining information for forming an image of desired image quality;
a storage device to store the image quality maintaining information before the image forming apparatus transitions to a sleep mode; and
an image quality maintaining control part that reads the image quality maintaining information from the storage device and controls the image forming part based on the read image quality maintaining information before the image forming apparatus returns after the sleep mode of the image forming apparatus is released.

2. The apparatus of claim 1, wherein the image quality maintaining control part reads the image quality maintaining information from the storage device and controls the image forming part based on the read image quality maintaining information simultaneously with the release of the sleep mode of the image forming apparatus.

3. The apparatus of claim 1, further comprising a fixing device that includes a temperature sensor and fixes the image formed on the sheet by the image forming part, wherein
after the image forming apparatus returns from the sleep mode, when a temperature detected by the temperature sensor reaches a specified temperature or higher, the image forming part forms the image on the sheet.

4. The apparatus of claim 1, wherein
the storage device includes timer information for causing the image forming apparatus to transition to the sleep mode, and
the image forming apparatus transitions to the sleep mode based on the timer information.

5. The apparatus of claim 1, wherein
the image forming part includes a plurality of image forming stations including a plurality of image carriers, and an exposure device to form electrostatic latent images on the plurality of image carriers,
the image quality maintaining adjustment pattern is a density adjustment pattern,
the detection part is a toner adhesion amount sensor to detect a density of the density adjustment pattern,
the image quality maintaining information is a density adjustment value for adjusting a density of the image to a desired density, and
the image quality maintaining control part includes a print control part to control the plurality of image forming stations and a laser control part to control the exposure device.

6. The apparatus of claim 5, wherein
each of the image forming stations includes
the image carrier,
a charging charger to uniformly charge a surface of the image carrier,
a developing device to supply a toner charged by a toner charging amount control unit to the surface of the image carrier, and
a photoreceptor cleaner to remove a toner on the surface of the image carrier, and
the exposure device includes
a laser oscillator that is driven by a laser driver and emits a laser beam, and
a tilt mirror that is driven by a mirror driver and guides the laser beam to the surface of the image carrier.

7. The apparatus of claim 6, wherein
the density adjustment value includes
a development bias value for charging the toner to a desired charging amount by the toner charging amount control unit,
a charging bias value for charging the surface of the image carrier to a desired potential by the charging charger, and
a laser power adjustment value for forming an electrostatic latent image charged to a desired potential on the surface of the image carrier by the laser oscillator.

8. The apparatus of claim 1, wherein
the image forming part includes an exposure device to irradiate laser beams to desired positions on a plurality of image forming stations including a plurality of image carriers,
the image quality maintaining adjustment pattern is a position adjustment pattern,
the detection part is a positioning sensor to detect the position adjustment pattern,
the image quality maintaining information is a position adjustment value for adjusting a position of a toner image constituting the image to a desired position, and
the image quality maintaining control part includes a laser control part to control the exposure device.

9. The apparatus of claim 8, wherein
the exposure device includes
a laser oscillator that is driven by a laser driver and emits a laser beam, and
a tilt mirror that is driven by a mirror driver and guides the laser beam to a surface of the image carrier.

10. The apparatus of claim 9, wherein
the position adjustment value includes
a timing adjustment value for emitting a laser beam at a desired timing to the surface of the image carrier by the laser oscillator, and
a mirror position adjustment value for guiding the laser beam to a desired position on the surface of the image carrier by the tilt mirror.

11. An image forming method comprising:
forming an image quality maintaining adjustment pattern by the image forming part on a transfer belt to convey a sheet;
detecting the image quality maintaining adjustment pattern;
calculating, based on a detection result of the image quality maintaining adjustment pattern, image quality maintaining information for forming an image of desired image quality;
storing the calculated image quality maintaining information in a storage device before an image forming apparatus transitions to a sleep mode;
reading the image quality maintaining information from the storage device and controlling the image forming part based on the read image quality maintaining information before the image forming apparatus returns after the sleep mode of the image forming apparatus is released.

12. The method of claim 11, wherein in controlling the image forming part, the image quality maintaining information is read from the storage device and the image forming part is controlled based on the read image quality maintaining information simultaneously with the release of the sleep mode of the image forming apparatus.

13. The method of claim 11, further comprising
detecting a temperature in a fixing device to fix the image formed on the sheet, wherein
after the image forming apparatus returns from the sleep mode, when the detected temperature reaches a desired temperature or higher, the image is formed on the sheet by the image forming part controlled based on the image quality maintaining information.

14. The method of claim 11, wherein
the image forming apparatus transitions to the sleep mode based on timer information that is stored in the storage device and is for causing the image forming apparatus to transition to the sleep mode.

15. The method of claim 11, wherein
the image forming part includes a plurality of image forming stations including a plurality of image carriers, and an exposure device to form electrostatic latent images on the plurality of image carriers,
the image quality maintaining adjustment pattern is a density adjustment pattern, and
the image quality maintaining information is a density adjustment value for adjusting a density of the image to a desired density.

16. The method of claim 15, wherein
each of the image forming stations includes
the image carrier,
a charging charger to uniformly charge a surface of the image carrier,
a developing device to supply a toner charged by a toner charging amount control unit to the surface of the image carrier, and
a photoreceptor cleaner to remove a toner on the surface of the image carrier, and
the exposure device includes
a laser oscillator that is driven by a laser driver and emits a laser beam, and
a tilt mirror that is driven by a mirror driver and guides the laser beam to the surface of the image carrier.

17. The method of claim 16, wherein
the density adjustment value includes
a development bias value for charging the toner to a desired charging amount by the toner charging amount control unit,
a charging bias value for charging the surface of the image carrier to a desired potential by the charging charger, and
a laser power adjustment value for forming an electrostatic latent image charged to a desired potential on the surface of the image carrier by the laser oscillator, and
in controlling the image forming part,
the toner charging amount control unit is controlled based on the development bias value,
the charging charger is controlled based on the charging bias value, and
the laser oscillator is controlled based on the laser power adjustment value.

18. The method of claim 11, wherein
the image forming part includes an exposure device to irradiate laser beams to desired positions on a plurality of image forming stations including a plurality of image carriers,
the image quality maintaining adjustment pattern is a position adjustment pattern, and
the image quality maintaining information is a position adjustment value for adjusting a position of a toner image constituting the image to a desired position.

19. The method of claim 18, wherein
the exposure device includes
a laser oscillator that is driven by a laser driver and emits a laser beam, and
a tilt mirror that is driven by a mirror driver and guides the laser beam to a surface of the image carrier.

20. The method of claim 19, wherein
the position adjustment value includes
a timing adjustment value for emitting a laser beam at a desired timing to the surface of the image carrier by the laser oscillator, and
a mirror position adjustment value for guiding the laser beam to a desired position on the surface of the image carrier by the tilt mirror, and
in controlling the image forming part,
the laser oscillator is controlled based on the timing adjustment value, and
the tilt mirror is controlled based on the mirror position adjustment value.
